(19) United States
(12) Patent Application Publication
(10) Pub. No.: US 2004/0192207 A1
(43) Pub. Date: Sep. 30, 2004

(54) Method and device for activating bluetooth TM devices through signaling

(76) Inventor: Pekka Ketola, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/789,395

(22) Filed: Feb. 27, 2004

(30) Foreign Application Priority Data
Feb. 27, 2003 (WO) PCT/IB03/00738

(51) Int. Cl. H04Q 7/20

(52) U.S. Cl. 455/41.2

(57) ABSTRACT

There is provided a method and device for activating a first Bluetooth device through signaling, said method comprising detecting a signal in said first Bluetooth device, said first Bluetooth device being in a sleep mode, said signal being sent from a second device.

### CROSS-REFERENCE TO RELATED APPLICATION

This application claims priority from International Application No. PCT/IB03/00738 filed Feb. 27, 2003.

### BACKGROUND OF THE INVENTION

The invention relates to the connection set up between two wireless low-power devices, especially Bluetooth™ devices. Bluetooth™ devices use low cost, low power, short range radio technology originally developed as a cable replacement to connect devices such as mobile phone handsets, headsets, and portable computers. Different power classes are defined with different short ranges e.g. 10 meters, 20 meters, or 100 meters. When two devices want to connect to each other some kind of notification of the need for connection must be made, and it must be ensured that both devices are activated. Devices may notify their need all the time or every now and then. Compromises must be made to save battery power, especially in small simple devices. Bluetooth is rapidly becoming a common accessory in mobile devices and in mobile terminal devices.

With an increasing spread of mobile telephones and Bluetooth (BT) devices, it is probable that a single user owns more than one mobile telephone or Bluetooth device. This can shortly be described as multi device ownership (MDO). Therefore it is required that a user can easily switch between two or more terminals or devices. This invention supports MDO in a very practical level. MDO is based on the idea that one user has more than one Bluetooth enabled device e.g. a telephone and Bluetooth enabled PDA (Personal digital assistant) or a Communicator for the use in the office, an individualized gaming and music phone for private use, an outdoor phone for sport and utility activities and a Bluetooth enabled desktop or laptop computer. It is therefore necessary that the personal data on the different devices can be synchronized between the devices e.g. on a daily basis. In many situations the synchronization is made by using a Bluetooth connection.

Because of the need to reduce power consumption the Bluetooth radio is only intermittently or periodically active to allow for longer operation times. This however creates a new problem which will surface with MDO and is emphasized for example during synchronization. The Bluetooth connection succeeds if both Bluetooth devices are switched on. Actually this is done by the user switching on the Bluetooth feature in the two devices manually to establish the connection.

It was known in the art to use a powering down signal to indicate that a Bluetooth device is going to enter a sleep mode but there is actually no method or device described to wake up the device from the sleep mode by remote signaling.

Wireless communication between several devices where at least one of the devices is battery driven (non-plugged), places special criteria to device discovery (idle mode operation from the radio perspective) since usually a battery driven device can not be continuously active. Hence, a trade off between connection setup, power efficiency and range is inevitable. In Bluetooth (BT) this trade-off is solved by compromising the connection set-up delay as well as the idle mode duty cycle. See the BT baseband specification.

In some cases it is desirable that the BT activation of two devices could be done from one place, for example from one phone. For example if three or more devices have to be synchronized, it is evident that it is not an easy task to try to switch on three different BT devices more or less simultaneously with only two hands.

When a user wants to synchronize two or more of his devices it is very likely that at least one of the handset terminals has its BT radio turned off. In case the user has mislaid or lost one of his devices the user can not find the device by waking the device up and induce e.g. a signal by a confirmation tone or an activated display illumination. Another application would be to synchronize three or more devices, e.g. in a phonebook synchronization of a company to ensure that every employee can easily access a certain number of important phonebook entries, such as company own fire service, security, office supply or post or computer service.

In the conventional case the user has to activate the BT radio in order to establish a connection. There are some practical inconveniences related to this fact, so in some cases the other device may be in a different place than the user or the status of the BT radio may not be indicated in the user interface so the user cannot easily determine, whether the radio is on or off.

### BRIEF SUMMARY OF THE INVENTION

Therefore, a wake up and communication setup method and device architecture is needed which is capable to overcome these problems.

It is desirable to simplify the use of several terminals and to make the BT interaction easier-to-use.

It is further desirable that the BT activation of two or more devices could be done from one (remote) place.

This invention overcomes the problem that a user has to operate two devices in a BT transaction. Instead, the user is now able to start and end the operation by using only one device.

In some cases a user benefits if the Bluetooth activation of two devices could be done from one place for example from one BT enabled phone.

In one embodiment of the present invention a method for activating a Bluetooth (BT) device through signaling is provided. The method provides wake-up and connection set-up for a BT radio device. The detection of the signal in said first BT device can be performed according to different detection techniques and according to the actual implementation of the BT device. The actual form of said signal can have various forms in the present invention. The signal can be e.g. a signal within the BT baseband, but is not restricted to BT. The signal is detected while the BT module of the device is in a sleep mode. So the normal BT receiver is supposed to be not active, the BT device being in a sleep mode.

It is also possible that the device which sends an activation signal is not part of the Bluetooth communication. That is, the activation signal can be sent from a device which is actually not a BT device. The type of activation signal and the type of detector used to detect the activation signal are interdependent. The activation signal for BT devices in a sleep mode may be generally standardized or can be respective proprietary manufacturer-specific signals or even types of signals. So the BT device to receive the activation signal can comprise more than one detector type to receive more than a single type of activation signal. The activation signal may also be composed of a number of different signal types, to enable a number of BT devices even from different manufacturers to be simultaneously activated to perform a BT-synchronization.

As the device sending said activation signal is not necessarily part of the Bluetooth communication, it can also be sent from a device that is not capable of performing BT communication. The activation signal can be transmitted for example from a RF (radio frequency) or WLAN- (wireless local area network) device. Alternatively, the wake up signal can be transmitted from a proprietary BT wake up device, sending activation signals on at least one of the different well known activation signal channels.

It is to be noted that the activation signal can be transferred via a network, to synchronize remote BT devices. For example, a user can activate a security camera on his summer cottage at Spain by sending a message from Finland and the camera would send pictures by Bluetooth to his neighbor in Spain. One way to implement this example would be to simultaneously send two wake up signals (e.g. via a communication network) to the camera and the BT device of the neighbor. Another way to implement this example would be to use a relay activation signal. In this case, the user sends a wake up signal to the first device (via a communication network) followed by a command to transmit in turn an activation signal(e.g. via BT), to synchronize with the second device, or vice versa.

In an example embodiment of the present invention said signal is sent from a second BT device. As stated above, the signals can be a RF-signal in the BT band, but is not restricted to BT or RF only.

In another example embodiment said signal further comprises an identification of a BT device. The method comprises detecting a signal in a sleep mode of said BT device, extracting an identification (ID) from said signal, and checking and in case confirming said identification. The method further comprises putting said BT device into an operative state and initiating a connection set up procedure.

The detection of the signal in said first BT device can be performed according to different detection techniques and according to the actual implementation of the BT device. The actual form of said signal can have various embodiments in the present invention. The signal is detected while the device is in a sleep mode. The signal is sent from another BT device which is supposed to be within the range of a connection. The signal can be a BT signal, but is not restricted to BT. Said signal comprises an identification of a BT device. The identification of the BT device can be the ID of the BT device that receives the signal, so that the receiving device knows if the signal is coming in to the right address. The identification of the BT device can be the ID of the BT device that sends the signal, so that the receiving device knows if the signal is coming from the right sender. The detection of the signal can be performed e.g. via a field strength indication signal or from another sub part of the BT device.

The extraction of said identification (ID) from said detected signal can be performed directly, during the detection or subsequently e.g. by a controller. The extraction is necessary to prevent that the BT device is automatically activated from any signal received. The ID can comprise the ID of one of said BT devices, or even a universal or proprietary ID or activation code. The signal can further comprise additional BT specific information to speed up a subsequent connection set up process.

The method checks and confirms said ID to verify or validate said ID, as a safety feature to prevent that unknown devices can induce a connection set up process. Thereby the waste of battery power can be prevented and data protection can be assured.

Said BT device is put into an operative state, if said extracted ID is confirmed, followed by the initiation of a connection set up procedure to set up a connection to said second BT device according to a BT protocol.

The present invention can send an activation request and information concerning this request through pre-call signaling.

By using this method a user can switch on a BT module of a BT enabled device using a remote device, without the need to be actually present, or to actually operate both devices. The present invention relates to a method to activate Bluetooth radio from a remote device, in order to perform Bluetooth activity, such as synchronization. The invention is based on the concepts as follows:

two devices can have secure communication by having pairing data identifying the devices.

The pairing can be handled by BT software.

a mobile terminal can detect incoming (phone) RF signals

a mobile terminal can send signals that can be detected by a local device

the signals can contain codes, such as pairing data

BT radio can be activated, if the request is received from a secure and identifiable source

For example, when a user returning home from work desires to synchronize his home phone with his work phone, he can just activate synchronization from his work phone and the phones are synchronized. This method is not restricted to a single pair of BT devices but can also be applied to three or more BT enabled devices. This method is safe because if a terminal that is queried does not recognize the ID sent to it by signaling, it refuses to activate its BT radio module.

In another example embodiment the method further initiates a synchronization by exchanging data with said second BT device after said connection set up has been performed. Alternatively, other data exchange processes can be performed to synchronize other data such as appointment book entries.

In another example embodiment, said signal is a BT signal. In case a BT signal is used it should be assured that the device can receive said signal, even if the BT module of the device is actually in a sleep mode. One possibility is to use e.g. an encoded carrier wave signal as a signal to produce digital RF-detector output, that can be processed by a processor or a controller. Other signals can also be applied to produce a digital coded detector output. The signal can also be an optical infrared (IR) signal if both devices are equipped with respective optical interfaces. In this case the signal is directly transferred from one device to another.

In yet another example embodiment, said signal is a smart message signal. The smart message comprises a computer program code to cause the receiving device to activate its BT module. It is clear that the receiving device has to be smart message enabled to receive said message and to perform the activation. In this case the signal is transmission is an indirect transmission, as the signal is transferred via a communication (telephone) network.

In another example embodiment, said identification is for identifying said first signaling BT device. In yet another example embodiment said identification is for identifying said second BT device to be activated. The identification can be performed by a Bluetooth-address, a UID (unique device identification) or by a negotiated identification. The present invention is not to be restricted by the actually used identification code. The use of a sender identification has the advantage that the receiving device can uniquely identify the sending device. The use of a receiver identification has the advantage that the sending device can uniquely identify the receiving device, and therefore can select a particular device from an arbitrary number of present devices and perform a receiver specific activation. Another advantage of the receiver identification resides in the fact that the receiving device needs only to compare two identifications, i.e. its own and the received, and does not have to determine a received identification in a number of stored device IDs. The signal can even comprise a sender ID and a receiver ID, to utilize the advantages connected to both IDs.

According to yet another aspect of the invention, a software tool is provided comprising program code means for carrying out the method for signaling based activation and connection set up of the preceding description when said program product is run on a computer or a radio device.

According to another aspect of the present invention, a computer program product downloadable from a server for carrying out the method for signaling based activation of the preceding description is provided, which comprises program code means for performing all of the steps of the preceding methods when said program is run on a computer or a network device.

According to yet another aspect of the invention, a computer program product is provided comprising program code means stored on a computer readable medium for carrying out the method for signaling based activation and connection set up of the preceding description when said program product is run on a computer or a radio device.

According to another aspect of the present invention a computer data signal is provided. The computer data signal is embodied in a carrier wave and represents a program that makes the computer perform the steps of the method contained in the preceding description, when said computer program is run on a computer, or a network device.

This software can e.g. be integrated in the personal software of a mobile telephone or any other personal trusted device.

According to another aspect of the present invention a Bluetooth (BT) device is provided, that is capable of being activated via signaling. The low power radio device comprises a detection component, a BT radio module and a controller, wherein said controller is connected to said detection component and said BT radio module. Said detection component is for detecting a signal, when said BT module is in a sleep mode, wherein said signal is sent from a second device. The controller is configured to put said BT radio module into an operative state, if said detection component detects a signal.

In another example embodiment the device further comprises a storage for storing identifications of BT devices. In this embodiment said detected signal comprises an identification of a BT device, being sent from another BT device. The controller is connected to said storage, and is configured to receive an identification from said detection component. The controller is further configured to confirm said identification on the basis of identifications which are stored in said storage. Said controller is also configured to put said BT radio module into an operative state, if said extracted identification is confirmed and said controller is configured to initiate said BT radio module to perform a connection set up procedure according to the BT protocol to set up a connection with said identified and confirmed other BT device.

The detection component is adapted for detecting a signal when said BT radio module is in a sleep mode, wherein said signal comprises an identification of a BT device, and wherein said signal is sent from a second BT device. The signal can directly or indirectly be received from said second BT device.

Said controller is configured to receive an identification from said detection component. The identification can be received in an encoded or in an extracted form. Said controller is further configured to confirm said identification on the basis of said stored identifications retrieved from said storage or memory. Said controller is also configured to put said BT radio module into an operative state, if said extracted identification has been confirmed. Said controller is further configured to initiate said BT radio module to perform a connection set up procedure to set up a connection to said identified and confirmed second BT device according to a BT protocol.

Said storage is adapted to store identifications of BT devices, to enable the controller to check, verify, confirm or validate said received identification.

Said BT radio module is connected to the controller to perform said connection set up procedure to set up a connection with said identified and confirmed other BT device according to a BT protocol.

In another example embodiment said detection component comprises an RF detector circuit. The detector can be a RF-to-DC converter, i.e., Schottky diode based converter, as depicted in FIG. 1. The detector can also be embodied e.g. as a BT signal detector, a smart message signal detector, an IR detector and/or a WLAN signal detector.

In yet another example embodiment, said Bluetooth (BT) device further comprises a mobile telephone module. Basically, the device according to this example embodiment is a BT enabled mobile phone or a BT and phone enabled PDA.

In yet another additional example embodiment said detection component comprises a smart message receiver of a mobile telephone or of a messaging pager. By using a smart messaging receiver the BT activation can be controlled by a non BT based signaling method.

### BRIEF DESCRIPTION OF THE DRAWINGS

In the following, the invention will be described in detail by referring to the enclosed drawings in which:

FIG. 1 is a signal detection component according to one embodiment of the present invention utilizing a high frequency detector according to the state of the art;

FIG. 2 is a flow chart of a signaling based activation method according to one embodiment of the present invention; and

FIG. 3 describes an implementation embodiment of the system that is based on the use of the power detector and a controller to initialize a BT module.

### DETAILED DESCRIPTION OF THE INVENTION

In the following a detailed description of well-known methods, interfaces, devices, and signaling techniques is omitted so as not to obscure the description of the invention.

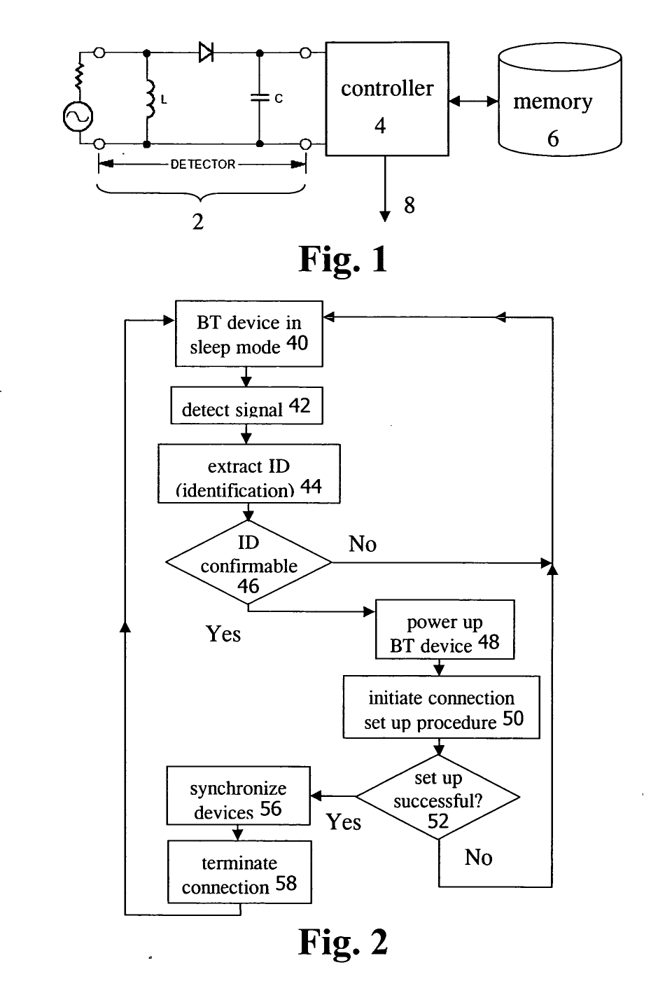

FIG. 1 is a detection component according to one embodiment of the present invention. The detection component comprises a high frequency detector 2 according to the state of the art. The figure depicts at the left side of the high frequency detector 2 a high frequency source with an internal resistance depicted as the resistor connected in series to the RF source. The detector itself is constituted by an impedance L, a capacitance C and a Schottky diode. The value of the impedance has to be selected to suppress DC voltages on the RF side of the detector, and the value of the capacitor C has to be selected to suppress RF components in the output of the detector. By selecting the values of the capacitor and the impedance, the detector can be tuned to a certain frequency. The Schottky diode is capable of rectifying even RF alternating voltages, as the switching time of this kind of diodes is very low.

According to one embodiment of the present invention a signal is fed to the detector comprising an on/off coded intermittent RF-signal encoding a digital device identification in the sequence of signals and pauses. The detector can further transform the interrupted rectified carrier signal to a digital signal, e.g. by using a Schmitt trigger, the signal can be adapted to the voltage used by the following controller 4, to prevent damage and signal misinterpretation.

An interrupted signal can be used to encode a device identification as in the case of the Morse code transmission modulation used by radio amateurs. An important difference to the Morse code modulation is that the depicted detector is not frequency selective, so the frequency of the signal can be nearly any arbitrary single or multi frequency signal.

The controller 4 then verifies the digital signal by assuming it contains a device identification. Therefore the controller e.g. compares the received code in the signal with at least one device identification, pre-stored in memory 6, as a safety and energy saving feature.

If the identification has been verified, the controller puts out a signal 8 to wake up the BT device, to set up a BT connection to synchronize e.g. phonebook entries or the like.

The present invention can be implemented as one of said cheap electronic devices that are to be attached to a mobile phone to indicate incoming calls. These devices can detect incoming signals, such as incoming calls and messages, and blink a light etc. when signaling is detected. This invention is partially based on the idea that similar early-signal detection could be used for simple messaging purposes, as described.

The present invention is not restricted to the details of the signaling. The present invention is not to be restricted by the CW coded signaling operation. The above example is only an exemplary embodiment of a very simple implementation of the present invention. Other signals will be described e.g. in the following description of FIG. 2.

FIG. 2 is a flow chart of a connection set up and signaling based wake up method according to one embodiment of the present invention. Assuming that two devices i.e. a communicator and a mobile phone need to be synchronized via BT, and the considered device (i.e. the phone) has a turned off BT radio module. In this example a phone and a communicator are chosen to visualize the different actions in the two devices. The invention is applicable to any kind of BT devices, and is not restricted to the exemplary devices used in this embodiment. The phone is initially in a sleep mode 40 wherein the BT module is turned off.

A user selects (not shown) a function “Synchronize” on the communicator and the communicator starts signaling that it is intended to “wake-up” or activate the BT module of the phone. The signaling contains a short code that e.g. identifies the communicator, and requests the phone to switch on its BT radio module.

The phone detects 42 the signaling and extracts 44 the identification code (ID). In a next step the ID is to be confirmed 46 by the phone as being valid, or as identifying a trusted device (assuming that the ID of the communicator has already been identified or confirmed as valid or trusted by the user of the phone). If the ID cannot be confirmed, the BT module of the phone stays turned off.

If the extracted ID has been verified, the phone activates 48 its BT radio module. The communicator and the phone can start a connection set up process 50. If the connection can be established successfully, a local synchronization process 56 via the BT connection can be performed, otherwise the BT module of the phone can return to the sleep mode. After synchronization the BT radio connection between the communicator and the phone, can be terminated 58. Finally, the phone and maybe the communicator can switch off their respective BT radio modules and return to their initial BT module sleep mode.

It should be noted that the method can be varied e.g. by changing the order of the detection of the signal and the powering up of the BT device/module. So in a varied method the identification of the calling device is carried out after the powering up of the BT module. In another variation the signaling device (here the communicator) transmits an identification of the phone, including the advantage that only one identification has to be stored (here the phone), and therefore the power consumption of the confirmation step can be reduced.

The best mode would be to use signaling to the extent that no actual connection is made or message is sent via a local telephone network, i.e. no costs are caused to the user.

Another method of the signaling includes the activation of the BT radio module using e.g. a smart message. In such an implementation the wake up procedure and the synchronization adds costs to the user. Another drawback of network (cellphone network) activation resides in the fact that both devices are not necessarily close enough to be able to set up a BT connection. The present invention is not to be restricted only to BT or telephone signals. The device sending the activation signal may be not part of the BT communication. The transmission of a single activation signal or a sheaf or salvo of different activation signals can also be used in case that the different BT-enabled devices to be synchronized have different activation interfaces. For example the device sending the activation signals can simultaneously use IR, RF (e.g. BT, WLAN), and telephone or messaging signals. In this case a single device can be used to incite a BT-synchronization/communication. For the present invention it may not be necessary that the device sending the activation message(es) is intended to take part in the incited BT-synchronization/communication. The synchronizer device may e.g. dispatch a smart message to one BT-enabled device, set up a telephone connection to a phone- device to perform a BT-wake up via a phone connection. When the phone connection is established, the device can send a (pre-selectable) number of types of activation signals to other BT-enabled devices for a simultaneous BT-wake up/synchronization.

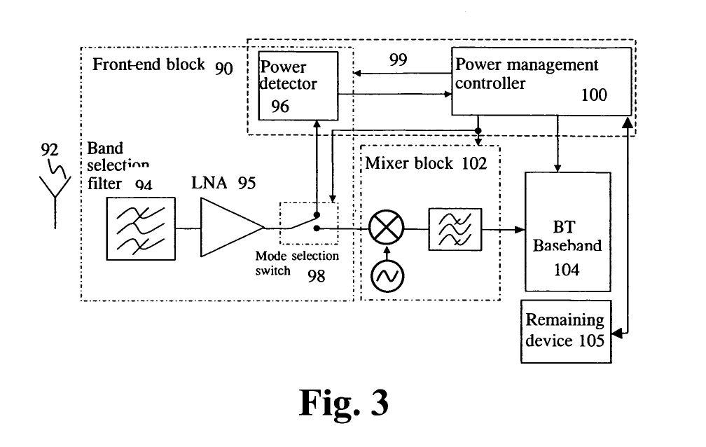

FIG. 3 describes an implementation embodiment of the system that is based on the use of a power detector and a controller to activate the BT receiver, and the baseband functionality of a BT device. The transmitter path of the BT module has been omitted for clarity. In this embodiment the system comprises a BT front end block 90, a BT power management and control block 99, a local oscillator and mixer receiver 102, and the BT baseband functionality 104. The front end block comprises an antenna 92, a band selection filter 94, a low noise amplifier 95, a mode selection switch 98 and the power detector 96. The power detector 96 is part of the front end block and is associated to the power management and control block 99.

In this embodiment, the power management and control block 99 is connected to a remaining device 105 such as e.g. a mobile telephone. The remaining device 105 is connected to the power management and control logic 100 to be able to receive an activation signal from said remaining device 105. Thereby the remaining device 105 can activate the BT module e.g. because of a received user input or any other signal such as a received smart message.

The system is based on the use of the power detector 96 to receive and evaluate a signal to activate the BT module comprising the local oscillator and mixer RF receiver 102 and the BT baseband functionality 104. The signal is received via the antenna 92, and transferred via the band selection filter 94, the low noise amplifier 95 and the mode selection switch to the detector 96. The detector 96 acts as a straight receiver and demodulates the received signal. The demodulated signal is transferred to the power management/controller 100 and is examined for a device identification. If a device identification can be detected, the power management/controller 100 powers up the mixer block and the baseband functionality 104, and switches the mode selection switch to connect the LNA 95 to the mixer Block 102. Thereby the BT receiver is activated.

Although in the figures there are only illustrated embodiments of BT-devices that can be activated via a received wake up signal, the invention also provides a wake up signaling device. The wake up signaling device comprises at least a single activation signal generator, to be able to transmit at least one activation signal. A wake up signaling device or activation signaling device, can be embodied as an independent device or may be implemented in any BT device. In a simple version the device can be embodied as a simple signal generator generating a simple un-modulated RF output. More sophisticated embodiments of an activation signaling device, can comprise different signal generators, and may be implemented in a BT device. The activation signaling device, can also comprise a memory to store (BT-) device IDs to selectively activate BT devices.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Method, comprising:
activating a first short range radio device after detecting a signal in said first short range radio device, said first short range radio device being in a sleep mode, said signal being sent from a second device.

2. Method according to claim 1 wherein said signal is sent from a second short range radio device.

3. Method according to claim 1 , wherein said signal further comprises an identification of a short range radio device.

4. Method according to claim 3 further comprising:
extracting said identification from said detected signal,
checking and confirming said identification,
putting said first short range radio device into an operative state, if said extracted identification is confirmed, and
initiating a connection set up procedure in said first short range radio device to set up a connection with said second Bluetooth short range radio device according to a short range radio protocol.

5. Method according to claim 4, further comprising:
initiating a synchronization by exchanging data with said second short range radio device, if said connection set up has been successful.

6. Method according to claim 1, wherein said signal is a radio frequency signal.

7. Method according to claim 6, wherein said signal is a short range radio signal.

8. Method according to claim 6, wherein said signal is a smart message signal.

9. Method according to claim 6, wherein said signal is a wireless local area network signal.

10. Method according to claim 3, wherein said identification is adapted for identifying said first short range radio device.

11. Method according to claim 3, wherein said identification is adapted for identifying said second short range radio device.

12. Software tool comprising program code means stored on a computer readable medium for carrying out the method of claim 1, when said software tool is run on a computer or network device.

13. Computer program product comprising program code means stored on a computer readable medium for carrying out the method of claim 1, when said program product is run on a computer or network device.

14. Computer program product comprising program code, downloadable from a server for carrying out the method of claim 1, when said program product is run on a computer or network device.

15. Computer data signal embodied in a carrier wave and representing a program that instructs a computer to perform the steps of the method of claim 1.

16. Short range radio device capable of being activated via signaling, comprising:
a short range radio module,
a controller connected to said short range radio module,
characterized by
a detection component connected to said controller, for detecting a signal sent from a second device when said short range radio module is in a sleep mode, wherein said controller is configured to put said short range radio module into an operative state, if said detection component detects a signal.

17. Short range radio device according to claim 16, further comprising a storage for storing identifications of short range radio devices,
and wherein said signal comprising an identification of a short range radio device is sent from a second short range radio device
and wherein said controller is connected to said storage, and wherein said controller is configured to receive an identification from said detection component, said controller configured to confirm said identification on the basis of said stored identifications, and said controller configured to put said short range radio module into an operative state, if said extracted identification is confirmed and said controller is configured to initiate said short range radio module to perform a connection set up procedure according to a short range radio protocol to set up a connection with said identified and confirmed other short range radio device.

18. Short range radio device according to claim 16, wherein said detection component comprises a radio frequency detector circuit.

19. Short range radio device according to claim 16, further comprising a mobile telephone module.

20. Short range radio device according to claim 19, wherein said detection component comprises a smart message receiver of said mobile telephone.
